(19) United States
(12) Patent Application Publication
(10) Pub. No.: US 2024/0394921 A1
(43) Pub. Date: Nov. 28, 2024

(54) OBJECT LOCALIZATION AND INFORMATION ENCODING SYSTEM

(71) Applicant: Apple Inc., Cupertino, CA (US)

(72) Inventors: Tushar Gupta, Stanford, CA (US); Arthur Y Zhang, San Jose, CA (US); Aleksandr M Movshovich, Santa Clara, CA (US); Ray L Chang, Saratoga, CA (US); Fletcher R Rothkopf, Los Altos, CA (US)

(73) Assignee: Apple Inc., Cupertino, CA (US)

(21) Appl. No.: 18/691,427

(22) PCT Filed: Sep. 22, 2022
(86) PCT No.: PCT/US2022/044461

§ 371 Date: Mar. 12, 2024

Related U.S. Application Data
(60) Provisional application No. 63/248,389, filed on Sep. 24, 2021.

(51) Int. Cl. G06T 7/80; G03B 17/56; G06T 5/20; H04N 23/80

(52) U.S. Cl. CPC G06T 7/80; G03B 17/565; G06T 5/20; H04N 23/80; G06T 2207/30204

(57) ABSTRACT

Fiducial patterns that include sub-patterns of dot-like markers are generated or applied on or in transparent glass or plastic material, for example an optical element such as a cover glass or lens attachment. A camera may capture multiple images through the glass or plastic element that include diffraction patterns caused by the fiducial patterns. The diffraction patterns from multiple images may be processed and analyzed to extract information including but not limited to centroids of the sub-patterns of the fiducial patterns. This information may, for example, be used to estimate location of the fiducial 10 patterns with respect to the camera, and thus to estimate pose of the glass or lens element with respect to the camera. Information such as serial numbers and prescriptions can also be encoded in the fiducial patterns and extracted from the respective diffraction patterns.

### PRIORITY APPLICATION

This application is a 371 of PCT Application No. PCT/US/2022/044461, filed Sep. 22, 2022, which claims benefit of priority to U.S. Provisional Patent Application No. 63/248,389,filed Sep. 24, 2021. The above applications are incorporated herein by reference. To the extent that any material in the incorporated application conflicts with material expressly set forth herein, the material expressly set forth herein controls.

### BACKGROUND

Fiducial patterns have been used in localization applications. For example, fiducial patterns that generate Barker Codes or Barker Code-like diffraction patterns have been used in some applications. Barker Codes exhibit a unique autocorrelation property-a sharp peak when the received and reference sequence align and near zero values for all other shifts. This impulse-like autocorrelation waveform with maximal side-lobe reduction is ideal for localization. One-dimensional (1D) Barker Codes are, for example, used in radar systems for deriving object range with maximal precision. However, for some applications that recover diffraction patterns from fiducials using cameras, fiducial patterns that generate Barker Code-like diffraction patterns on a camera sensor have to be optimized for each camera. Thus, Barker Codes may be too complex and expensive for use in some applications.

### SUMMARY

Various embodiments of methods and apparatus in which fiducial patterns comprising sub-patterns of dot-like markers are generated or applied on or in transparent glass or plastic material, for example optical elements such as cover glasses or lens attachments used in or with a head-mounted device. Cameras are used to capture multiple images through a glass or plastic element that include diffraction patterns caused by the fiducial patterns. The diffraction patterns from the multiple images can be processed and analyzed to extract information including but not limited to centroids of the sub-patterns of the fiducial patterns. This information may, for example, be used to estimate location of the fiducial patterns with respect to the cameras, and thus to estimate pose of the glass or lens element with respect to the cameras.

Embodiments of systems are described in which fiducial patterns that produce diffraction patterns at an image sensor (also referred to as a camera sensor) are etched or otherwise provided on a cover glass (CG) in front of a camera. The fiducial patterns are configured to affect light passing through the cover glass to cause diffraction patterns at the camera sensor. The “object” in the object location methods described herein may be the fiducial patterns that cause the diffraction patterns as captured in images by the camera. Captured images including the diffraction patterns can be deconvolved with a known pattern to determine peaks or centroids of sub-patterns within the diffraction pattern. Misalignment of the cover glass with respect to the camera post-t0 (e.g., calibration performed during or after assembly of the system at time 0) can be derived by detecting shifts in the location of the detected peaks with respect to the calibrated locations. Embodiments of systems that include multiple cameras behind a cover glass with one or more fiducials on the cover glass in front of each camera are also described. In these embodiments, the diffraction patterns caused by the fiducials at the various cameras may be analyzed to detect movement or distortion of the cover glass in multiple degrees of freedom.

In addition, embodiments of systems are described in which fiducial patterns that produce diffraction patterns at a camera sensor are etched or otherwise provided in lens attachments, for example prescription lenses that can be attached to the inner or outer surfaces of a cover glass (CG) in front of a camera. The fiducial patterns are configured to affect light passing through the lenses to cause diffraction patterns at the camera sensor. Captured images including the diffraction patterns can be deconvolved with a known pattern to determine peaks or centroids of sub-patterns within the fiducial pattern. This information can be used, for example, to determine alignment of the lenses with respect to the camera.

In addition, the fiducial patterns described herein may be used to encode information about a cover glass and/or lens attachment, for example prescription information for a lens, part numbers, unique identifiers, serial numbers, etc. This information may be recovered from the diffraction patterns captured at the cameras and used, for example, to make mechanical or software adjustments in the system to adapt the system to the particular glass or lens.

The signal of the dot patterns in the fiducial pattern is low, and the fiducial pattern cannot be seen with the naked eye. Using a video stream to integrate the signal over many frames in a stream, the fiducial pattern can be recovered. The pipeline for recovering the signal from the frames may involve spatial filtering to remove the background, and then deconvolution with the known pattern to recover the response.

The fiducial patterns can be printed on the surface, laminated, or created as subsurface patterns using any of various manufacturing techniques (ink printing and laser ablation, in a laminate applied to the cover glass, subsurface laser marking for plastic lenses, etc.)

### BRIEF DESCRIPTION OF THE DRAWINGS

FIG. 1A illustrates a system in which a glass or lens includes a fiducial pattern that causes a diffraction pattern on a camera sensor, according to some embodiments.

FIG. 1B illustrates a system in which a glass or lens includes multiple fiducial patterns that cause diffraction patterns on a camera sensor, according to some embodiments.

FIG. 1C illustrates a system with multiple cameras in which a glass or lens includes multiple fiducial patterns that cause diffraction patterns on the camera sensors, according to some embodiments.

FIG. 2A illustrates a simple sub-pattern that includes a ring of dots or markers, according to some embodiments.

FIG. 2B illustrates an example diffraction pattern caused by a sub-pattern as illustrated in FIG. 2A, according to some embodiments.

FIG. 3A illustrates an example fiducial pattern that includes two or more rings of sub-patterns as illustrated in FIG. 2A, according to some embodiments.

FIG. 3B illustrates an example diffraction pattern caused by a fiducial pattern as illustrated in FIG. 3A, according to some embodiments.

FIG. 4 graphically illustrates a process for extracting information from a diffraction pattern caused by a fiducial pattern, according to some embodiments.

FIG. 5 graphically illustrates a process for extracting information from a diffraction pattern caused by a sub-pattern in a fiducial pattern, according to some embodiments.

FIG. 6 illustrates the processing of input images to extract centroid or peak information from diffraction patterns in the images, according to some embodiments.

FIG. 7 illustrates a pad print and laser ablation process for generating fiducial patterns, according to some embodiments.

FIG. 8 illustrates a laser subsurface marking process for generating fiducial patterns, according to some embodiments.

FIGS. 9 and 10 illustrate a nano-imprinting lithography process for generating fiducial patterns, according to some embodiments.

FIG. 11 illustrates example fiducial patterns on a cover glass, according to some embodiments.

FIG. 12 illustrates example fiducial patterns on attachable lenses, according to some embodiments.

FIG. 13 illustrates another example fiducial pattern that includes multiple different sub-patterns, according to some embodiments.

FIG. 14 illustrates one of the sub-patterns from the fiducial pattern of FIG. 13, according to some embodiments.

FIG. 15 is a flowchart of a method for checking for shifts in the cover glass of a system, according to some embodiments.

FIG. 16 is a flowchart of a method for deriving information from diffraction patterns causes by fiducials on or in a glass or lens, according to some embodiments.

FIGS. 17 and 18 illustrate an example device in which embodiments may be implemented.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware-for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### DETAILED DESCRIPTION

Various embodiments of methods and apparatus in which fiducial patterns comprising sub-patterns of dot-like markers are generated or applied on or in transparent glass or plastic material, for example optical elements such as cover glasses or lens attachments used in or with a head-mounted device. Cameras are used to capture multiple images through the glass or plastic that include diffraction patterns caused by the fiducial patterns. The diffraction patterns from the multiple images can be processed and analyzed to extract information including but not limited to centroids of the sub-patterns of the fiducial patterns. This information may, for example, be used to estimate location of the fiducial patterns with respect to the cameras, and thus to estimate pose of the glass or lens element with respect to the cameras.

Embodiments of systems are described in which fiducial patterns that produce diffraction patterns at a camera sensor are etched or otherwise provided on a cover glass (CG) in front of a camera. The fiducial patterns are configured to affect light passing through the cover glass to cause diffraction patterns at the camera sensor. Captured images including the diffraction patterns can be deconvolved with a known pattern to determine peaks or centroids of sub-patterns within the fiducial pattern. Misalignment of the cover glass with respect to the camera post-t0 (e.g., calibration performed during or after assembly of the system at time 0) can be derived by detecting shifts in the location of the detected peaks with respect to the calibrated locations. Embodiments of systems that include multiple cameras behind a cover glass with one or more fiducials on the cover glass in front of each camera are also described. In these embodiments, the diffraction patterns caused by the fiducials at the various cameras may be analyzed to detect movement or distortion of the cover glass in multiple degrees of freedom.

In addition, embodiments of systems are described in which fiducial patterns that produce diffraction patterns at a camera sensor are etched or otherwise provided in lens attachments, for example prescription lenses that can be attached to the inner or outer surfaces of a cover glass (CG) in front of a camera. The fiducial patterns are configured to affect light passing through the lenses to cause diffraction patterns at the camera sensor. Captured images including the diffraction patterns can be deconvolved with a known pattern to determine peaks or centroids of sub-patterns within the fiducial pattern. This information can be used, for example, to determine alignment of the lenses with respect to the camera.

In addition, the fiducial patterns described herein may be used to encode information about a cover glass and/or lens attachments, for example prescription information for a lens, identifiers, serial numbers, etc. This information may be recovered from the diffraction patterns captured at the cameras and used, for example, to make mechanical or software adjustments in the system to adapt the system to the particular glass or lens.

The signal of the dot patterns in the fiducial pattern is low, and the fiducial pattern cannot be seen with the naked eye. Using a video stream to integrate the signal over many frames in a stream, the fiducial pattern can be recovered. The pipeline for recovering the signal from the frames may involve spatial filtering to remove the background, and then deconvolution with the known pattern to recover the response.

The fiducial patterns can be printed on the surface, laminated, or created as subsurface patterns using any of various manufacturing techniques (ink printing and laser ablation, in a laminate applied to the cover glass, subsurface laser marking for plastic lenses, etc.)

The fiducial patterns described herein may be used in any object localization system, in particular in systems that are within a range (e.g., 0.05 mm-5000 mm) of the camera. Embodiments may, for example, be used for stereo (or more than 2) camera calibration for any product with more than one camera. An example application of the fiducial patterns described herein is in computer-generated reality (CGR) (e.g., virtual or mixed reality) systems that include a device such as headset, helmet, goggles, or glasses worn by the user, which may be referred to herein as a head-mounted device (HMD).

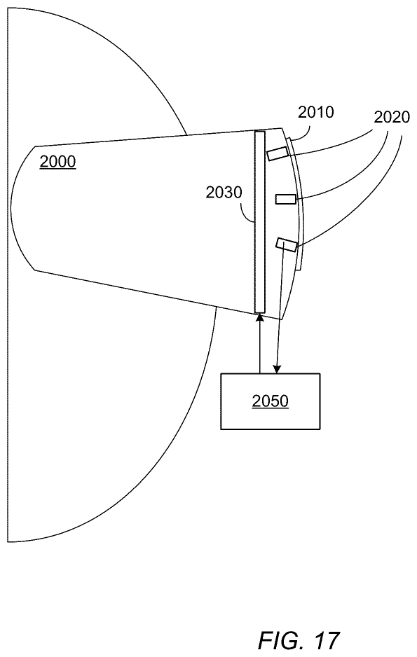

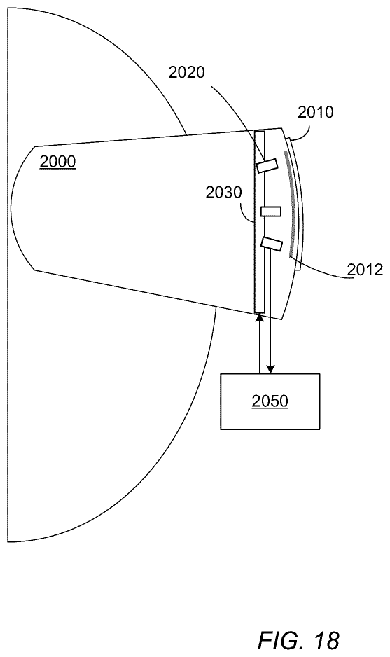

FIGS. 17 and 18 illustrate an example device in which embodiments may be implemented. As shown in FIG. 17, the device 2000 may include one or more cameras 2020 located behind a flat or curved cover glass 2010. One or more of the cameras 2020 may capture images of the user's environment through the cover glass 2010; the cameras 2020 may include one or more of RGB cameras, infrared (IR) cameras, or other types of cameras or imaging systems. The images captured by the camera(s) 2020 may be processed by algorithms implemented in software and hardware 2050 (e.g., processors (system on a chip (SOC), CPUs, image signal processors (ISPs), graphics processing units (GPUs), encoder/decoders (codecs), etc.), memory, etc.) generate and render frames that include virtual content that are displayed (e.g., on display screen(s) 2030) by the device 2000 for viewing by the user. The image processing software and hardware 2050 may be implemented on the device 2000, on a base station that communicates with the device 2000 via wired and/or wireless connections, or on a combination of the device 2000 and a base station. The image processing algorithms may be sensitive to any distortion in the captured images, including distortion introduced by the cover glass 2010. Alignment of the cover glass 2010 with respect to the camera(s) 2020 may be calibrated at an initial time t0, and this cover glass alignment information may be provided to the image processing algorithms to account for any distortion caused by the cover glass 2010. However, the cover glass 2010 may shift or become misaligned with the cameras 2020 during use, for example by bumping or dropping the device 2000.

As shown in FIG. 18, in some embodiments of such a device, an attachable/detachable lens 2012 (referred to herein as a lens attachment) may be attached on or near the inner surface of the cover glass 2010, or alternatively on or near the outer surface of the cover glass 2010. Lens 2012 may, for example be a prescription lens particular to the user of the device 2000. The image processing algorithms may be sensitive to any distortion in the captured images, including distortion introduced by the lens 2012.

In some embodiments, fiducial patterns that cause diffraction patterns at the camera sensors may be etched or otherwise applied to the cover glass in front of the camera(s) of the device. A fiducial pattern may include one or more sub-patterns of dot-like markers that are generated or applied on or in the transparent glass or plastic material of the cover glass. As necessary (e.g., each time the device is turned on, or upon detecting a sudden jolt or shock to the device), one or more images captured by the camera(s) may be analyzed using known patterns applied to the image(s) in a deconvolution process or technique to detect peaks (centroids of the diffraction patterns caused by the fiducial patterns on the cover glass) in the images. Locations of these centroids may then be compared to the calibrated alignment information for the cover glass to determine shifts of the cover glass with respect to the camera(s) in one or more degrees of freedom.

In some embodiments, fiducial patterns that cause diffraction patterns at the camera sensors may be etched or otherwise applied to the lens attachment in front of the camera(s) of the device. These fiducial patterns may also include one or more sub-patterns of dot-like markers that are generated or applied on or in the transparent glass or plastic material of the lenses. As necessary (e.g., each time the device is turned on, upon detecting that the lenses have been attached to the cover glass, or upon detecting a sudden jolt or shock to the device), one or more images captured by the camera(s) may be analyzed using known patterns applied to the image(s) in a deconvolution process or technique to detect peaks (centroids of the diffraction patterns caused by the fiducial patterns on the lenses) in the images. Locations of these centroids may then be used to determine pose of the lenses with respect to the camera(s) in one or more degrees of freedom.

In addition, the fiducial patterns described herein may be used to encode information about a cover glass and/or lens attachment, for example prescription information for a lens, serial numbers, etc. This information may be recovered from the diffraction patterns captured at the cameras and used, for example, to make mechanical or software adjustments in the system to adapt the system to the particular glass or lens.

One or more fiducial patterns may be provided on the cover glass or on the lenses for each camera. Using multiple (e.g., at least three) fiducials for a camera may allow shifts of the cover glass or lenses with respect to the camera to be determined in more degrees of freedom.

For a given camera, if more than one fiducial pattern is used for the camera (i.e., etched on the cover glass or lens in front of the camera), the fiducial patterns may be configured to cause effectively the same diffraction pattern on the camera sensor, or may be configured to cause different diffraction patterns on the camera sensor. If two or more different diffraction patterns are used for a camera, a respective known pattern is applied to image(s) captured by the cameras for each diffraction pattern to detect the peaks corresponding to the diffraction patterns. Further, the same or different diffraction patterns may be used for different ones of the device's cameras.

Curvature and thickness of the cover glass may require that the fiducial patterns required to cause the same diffraction pattern at different locations for a given camera are at least slightly different. Further, the fiducial patterns required to cause the same diffraction pattern for two different cameras may differ depending on one or more factors including but not limited to curvature and thickness of the cover glass at the cameras, distance of the camera lenses from the cover glass, optical characteristics of the cameras (e.g., F-number, focal length, defocus distance, etc.), and type of camera (e.g., visible light vs. IR cameras). Note that, if a given camera has one or more variable settings (e.g., is a zoom-capable camera and/or has an adjustable aperture stop), the method may require that the camera be placed in a default setting to capture images that include usable diffraction pattern(s) caused by fiducials on the cover glass.

The fiducials on a cover glass or lens effectively cast a shadow on the camera sensor, which shows up in images captured by the camera. If a fiducial is large and/or has high attenuation (e.g., 50% attenuation of input light), the shadow will be easily visible in images captured by the camera and may affect the image processing algorithms. Thus, embodiments of fiducials with very low attenuation (e.g., 1% or less attenuation of input light) are provided. These low attenuation fiducials cast shadows (diffraction patterns) that are barely visible to the naked eye, if at all visible. However, the methods and techniques described herein can still detect correlation peaks from these patterns, for example by integrating over multiple (e.g., 100 or more) frames of a video stream.

In some embodiments, signal processing techniques may be used to extract the correlation peaks for changing background scenes. A constraint is that the background image cannot be easily controlled. An ideal background would be a completely white, uniform background; however, in practice, the background scene may not be completely white or uniform. Thus, signal processing techniques (e.g., filtering and averaging techniques) may be used to account for the possibility of non-ideal backgrounds. In some embodiments, an algorithm may be used that applies spatial frequency filters to remove background scene noise. In some embodiments, averaging may be used to reduce signal-to-noise ratio (SNR) and reduce the effect of shot or Poisson noise. In some embodiments, frames that cannot be effectively filtered are not used in averaging.

In some embodiments, the deconvolution information may be collected across multiple images and averaged to reduce the signal-to-noise ratio (SNR) and provide more accurate alignment information. Averaging across multiple images may also facilitate using fiducials with low attenuation (e.g., 1% or less attenuation). Further, analyzing one image provides alignment information at pixel resolution, while averaging across multiple images provides alignment information at sub-pixel resolution.

In some embodiments, peaks from images captured by two or more cameras of the device may be collected and analyzed together to determine overall alignment information for the cover glass or lenses. For example, if the cover glass shifts in one direction and the cameras are all stationary, the same shift should be detected across all cameras. If there are differences in the shifts across the cameras, bending or other distortion of the cover glass may be detected.

While embodiments of fiducials etched on a cover glass of a system to cause diffraction patterns at a camera sensor are described in reference to applications for detecting misalignment of a cover glass or lens with a camera of the system, embodiments of fiducials to cause diffraction patterns at a camera sensor may be used in other applications. For example, fiducials may be used to cause diffraction patterns that encode information. As an example of encoding information, lens attachments may be provided that go over the cover glass of a system (e.g., of an HMD) to provide optical correction for users with vision problems (myopia, astigmatism, etc.). These lens attachments may cause distortions in images captured by the cameras of the system, and as noted above image processing algorithms of the system are sensitive to distortion. One or more fiducial patterns may be etched into the lens attachments that, when analyzed using respective known patterns, provide information including information identifying the respective lens attachment. This information may then be provided to the image processing algorithms so that the algorithms can account for the particular distortion caused by the respective lens attachment.

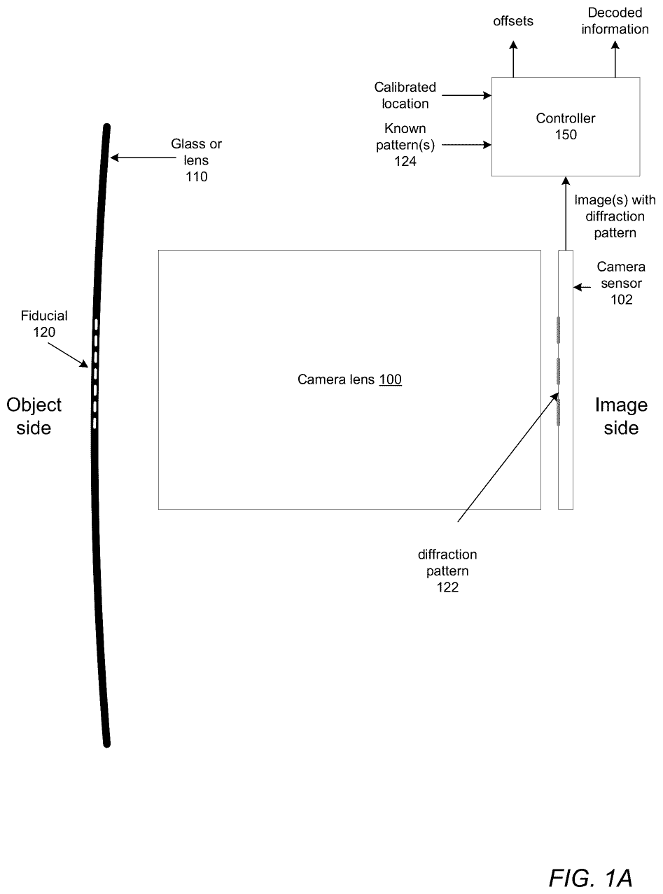

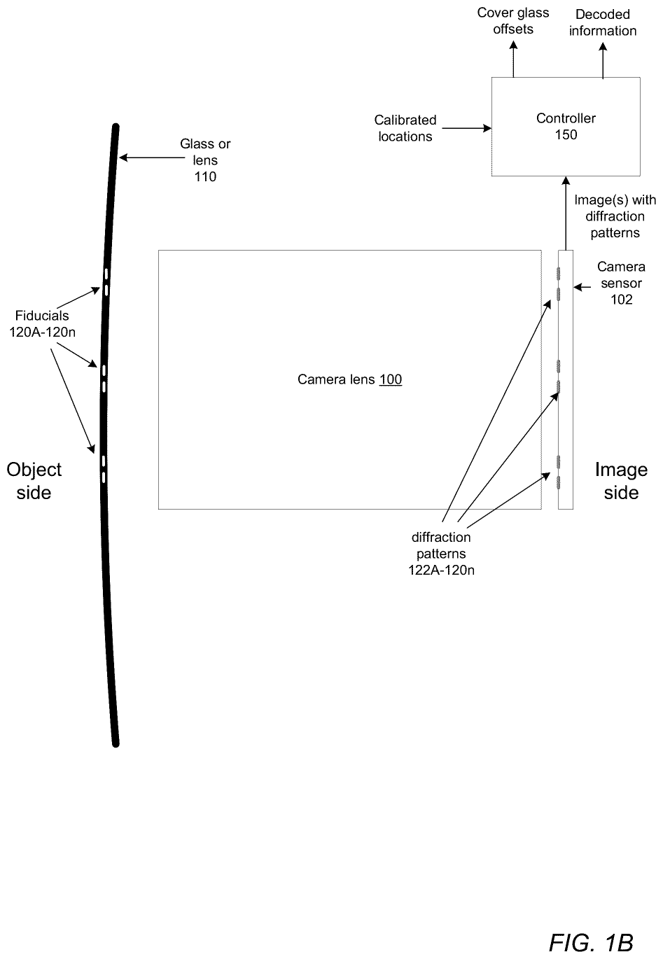

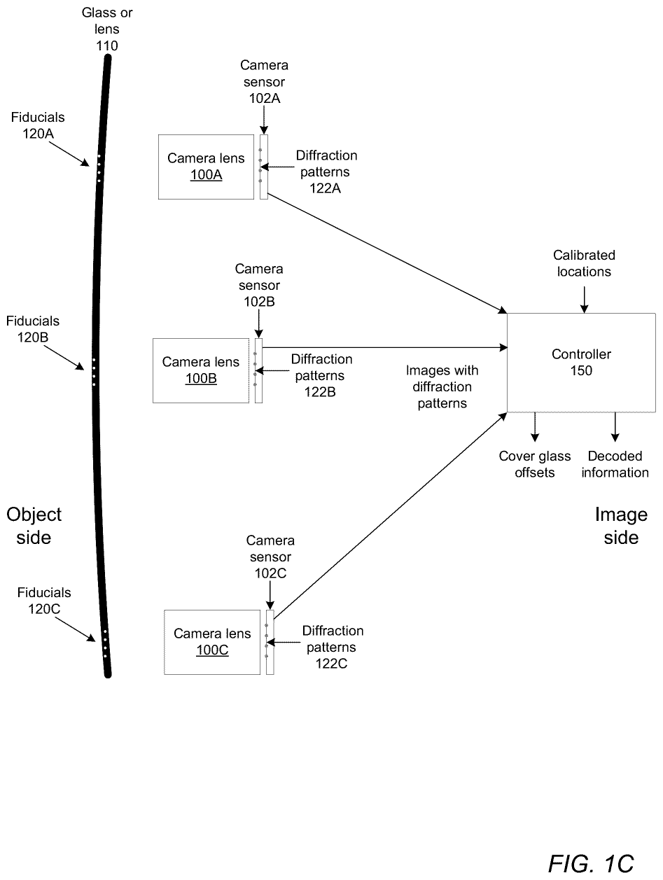

FIG. 1A illustrates a system in which a cover glass or attachable lens includes a fiducial pattern that causes a diffraction pattern on a camera sensor, according to some embodiments. The system may include a camera that includes a camera lens 100 and camera sensor 102 located behind a glass or lens 110 of the system (e.g., a cover glass of a head-mounted device (HMD), or an attachable lens). The glass or lens 110 may be, but is not necessarily, curved, and may, but does not necessarily, have optical power. A fiducial 120 may be etched or otherwise applied to or integrated in the cover glass 110 in front of the camera lens 100. The fiducial 120 is configured to affect input light from an object field in front of the camera to cause a diffraction pattern 122 at an image plane corresponding to a surface of the camera sensor 102. Images captured by the camera sensor 102 contain a “shadow” that corresponds to the diffraction pattern 122 caused by the fiducial 120.

The system may also include a controller 150. The controller 150 may be implemented in the HMD, or alternatively may be implemented at least in part by an external device (e.g., a computing system) that is communicatively coupled to the HMD via a wired or wireless interface. The controller 150 may include one or more of various types of processors, image signal processors (ISPs), graphics processing units (GPUs), coder/decoders (codecs), and/or other components for processing and rendering video and/or images. While not shown, the system may also include memory coupled to the controller 150. The controller 150 may, for example, implement algorithms that render frames that include virtual content based at least in part on inputs obtained from one or more cameras and other sensors on the HMD, and may provide the frames to a projection system of the HMD for display. The controller 150 may also implement other functionality of the system, for example eye tracking algorithms.

The image processing algorithms implemented by controller 150 may be sensitive to any distortion in images captured by the camera, including distortion introduced by the glass or lens 110. Alignment of the glass or lens 110 with respect to the camera may be calibrated at an initial time to, and this alignment information may be provided to the image processing algorithms to account for any distortion caused by the glass or lens 110. However, the glass or lens 110 may shift or become misaligned with the camera during use, for example by bumping or dropping the HMD.

The controller 150 may also implement methods for detecting shifts in the glass or lens 110 post-t0 based on the diffraction pattern 122 caused by the fiducial 120 on the cover glass 110 and on a corresponding known diffraction pattern. These algorithms may, for example be executed each time the HMD is turned on, upon detecting the presence of an attachable lens, or upon detecting a sudden jolt or shock to the HMD. Images captured by the camera may be analyzed by controller 150 by applying the known pattern(s) 124 to the image(s) in a deconvolution process to detect peaks (centroids of sub-patterns within the diffraction patterns) in the images. The locations and arrangements of the detected centroids may then be compared to the calibrated locations for the glass or lens 110 to determine shift of the glass or lens 110 with respect to the camera in one or more degrees of freedom. Offsets from the calibrated locations determined from the shift may then be provided to the image processing algorithms to account for distortion in images captured by the camera caused by the shifted glass or lens 110.

In some embodiments, the deconvolution information may be collected across multiple images and averaged to reduce the signal-to-noise ratio (SNR) and provide more accurate alignment information. Averaging across multiple images may also facilitate using fiducials 120 with low attenuation (e.g., 1% or less attenuation). Further, analyzing one image provides alignment information at pixel resolution, while averaging across multiple images provides alignment information at sub-pixel resolution.

Various fiducials 120 that produce different diffraction patterns 122 are described. Corresponding known patterns 124, when applied to the diffraction patterns 122 captured in images by the camera in the deconvolution process, provide peaks that may be used to detect shifts in the cover glass 110.

FIG. 1B illustrates a system in which a glass or lens includes multiple fiducial patterns that cause diffraction patterns on a camera sensor, according to some embodiments. The system may include a camera that includes a camera lens 100 and camera sensor 102 located behind a glass or lens 110 of the system (e.g., a cover glass of a head-mounted device (HMD), or an attachable lens). The glass or lens 110 may be, but is not necessarily, curved, and may or may not have optical power. Multiple fiducials 120A-120n may be etched or otherwise applied to or integrated in the glass or lens 110 in front of the camera lens 100. The fiducials 120 are configured to affect input light from an object field in front of the camera to cause diffraction patterns 122A-122n at an image plane corresponding to a surface of the camera sensor 102. Images captured by the camera sensor 102 contain “shadows” that correspond to the diffraction patterns 122A-122n caused by the fiducials 120A-120n.

Images captured by the camera may be analyzed by controller 150 by applying the known pattern(s) 124 to the image(s) in a deconvolution process to detect peaks (centroids of sub-patterns within the diffraction patterns) in the image(s). The locations and arrangements of the detected centroids may then be compared to the calibrated locations for the glass or lens 110 to determine shift of the glass or lens 110 with respect to the camera in one or more degrees of freedom. Offsets determined from the shift may then be provided to the image processing algorithms to account for any distortion in images captured by the camera caused by the shifted glass or lens 110.

Using multiple fiducials 120A-120n for a camera may allow shifts of the cover glass with respect to the camera to be determined in more degrees of freedom than using just one fiducial 120.

The fiducials 120A-120n may be configured to cause effectively the same diffraction pattern 122 on the camera sensor 102, or may be configured to cause different diffraction patterns 122 on the camera sensor 102. If two or more different diffraction patterns 122 are used for a camera, a respective known pattern 124 is applied to image(s) captured by the cameras for each diffraction pattern 122 to detect the peaks corresponding to the diffraction patterns 122.

Curvature and thickness of the cover glass 110 may require that the fiducial patterns 120 required to cause the same diffraction pattern 122 at different locations for the camera are at least slightly different.

FIG. 1C illustrates a system with multiple cameras in which a glass or lens includes multiple fiducial patterns that cause diffraction patterns on the respective camera sensors, according to some embodiments. The system may include two or more cameras (three, in this example) each including a camera lens (100A-100C) and camera sensor (102A-102C) located behind a glass or lens 110 of the system (e.g., a cover glass of a head-mounted device (HMD) or an attachable lens). The glass or lens 110 may be, but is not necessarily, curved. Fiducials 120A-120C may be etched or otherwise applied to or integrated in the glass or lens 110 in front of respective camera lenses 100A-100C. The fiducials 120 for a given camera are configured to affect input light from an object field in front of the camera to cause diffraction patterns 122 at an image plane corresponding to a surface of the respective camera sensor 102. Images captured by the camera sensor 102 contain “shadows” that correspond to the diffraction patterns 122 caused by the respective fiducials 120.

The fiducial patterns 120 required to cause the same diffraction pattern for two different cameras may differ depending on one or more factors including but not limited to curvature and thickness of the glass or lens 110 at the cameras, distance of the camera lenses 100 from the glass or lens 100, optical characteristics of the cameras (e.g., F-number, focal length, defocus distance, etc.), and type of camera (e.g., visible light vs. IR cameras).

One or more images captured by a camera may be analyzed by controller 150 by applying the known pattern(s) 124 to the image(s) in a deconvolution process to detect centroids of the diffraction patterns 122 in the image(s). The locations of the detected centroids may then be compared to the calibrated locations for the glass or lens 110 to determine shift of the glass or lens 110 with respect to the camera in multiple degrees of freedom. Offsets determined from the shift may then be provided to the image processing algorithms to account for any distortion in images captured by the camera caused by the shifted glass or lens 110.

In some embodiments, peaks from images captured by two or more of the cameras in the system may be collected and analyzed by controller 150 together to determine overall alignment information for the cover glass 110. For example, if the glass or lens 110 shifts in one direction and the cameras are all stationary, the same shift should be detected across all cameras 110. If there are differences in the shifts across the cameras, bending or other distortion of the glass or lens 110 may be detected.

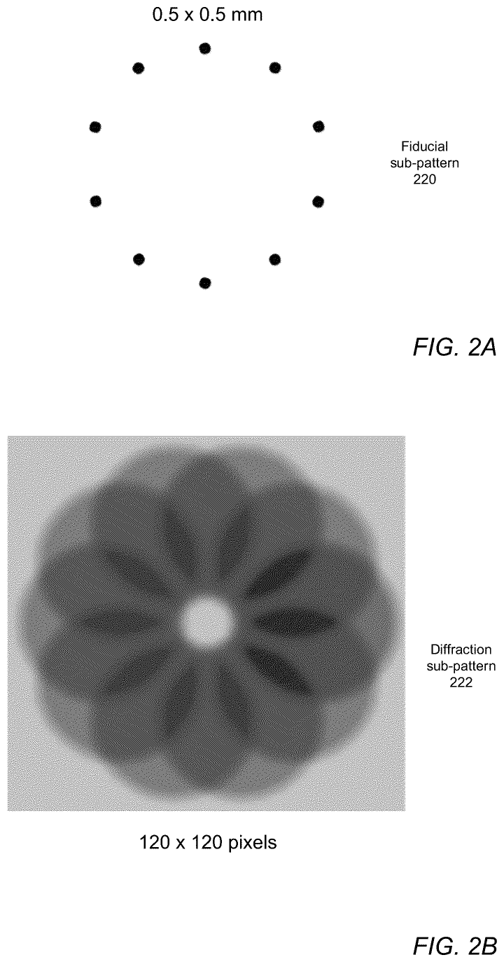

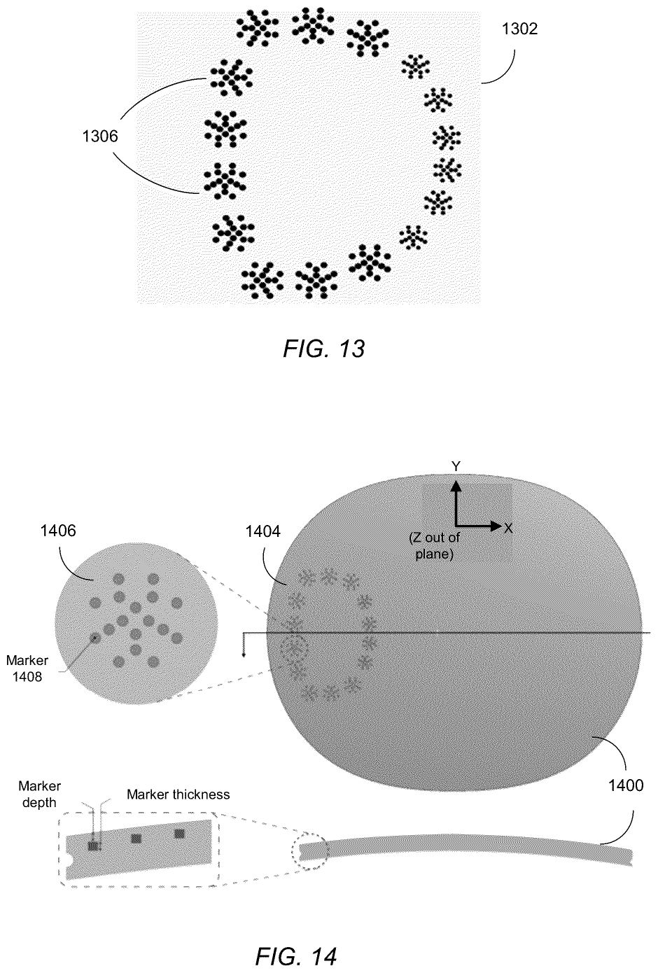

FIG. 2A illustrates an example fiducial sub-pattern 220 that includes a ring of dots or markers, according to some embodiments. This example sub-pattern 220 is circular; however, other geometric or irregular shapes may be used. The sub-pattern 220 may include more or fewer dots, and the dots can be otherwise arranged, for example as illustrated in FIG. 13. This example is 0.5×0.5 millimeters, but sub-patterns 220 may be larger or smaller. The sub-pattern 220 is configured to affect input light from an object field in front of the camera to cause a diffraction sub-pattern at an image plane corresponding to a surface of a camera sensor as illustrated in FIG. 2B.

FIG. 2B illustrates an example diffraction sub-pattern 222 caused by a fiducial sub-pattern 220 as illustrated in FIG. 2A, according to some embodiments. The fiducial sub-pattern 220 effectively casts a shadow on the camera sensor, which shows up as a diffraction pattern 222 in images captured by the camera sensor. In a single image, the sub-pattern 222 is not visible. However, integrated over many video frames (e.g., 100 or more frames), the sub-pattern 222 may be recovered and processed, for example using a deconvolution method, to recover information about the source sub-pattern 220.

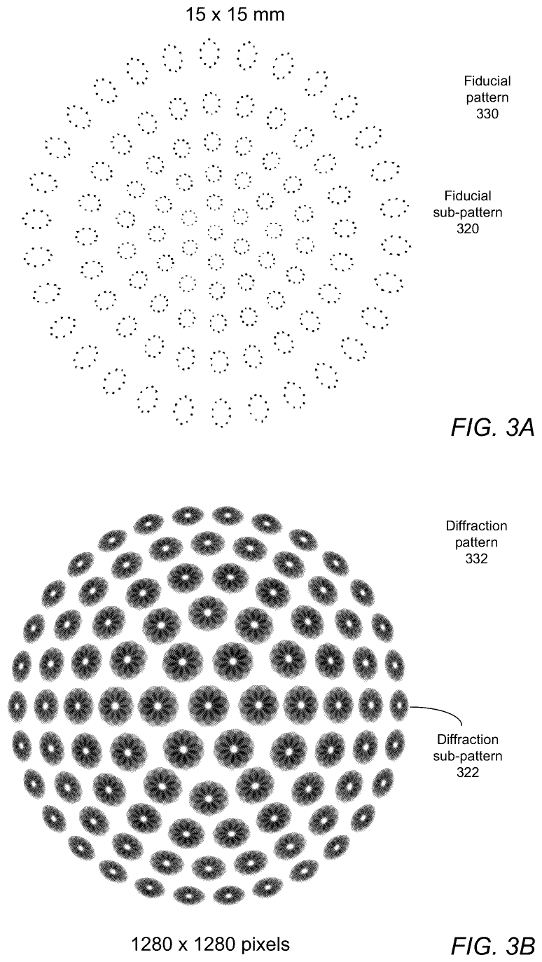

FIG. 3A illustrates an example fiducial pattern 330 that includes two or more rings of sub-patterns 320 as illustrated in FIG. 2A, according to some embodiments. This example fiducial pattern 330 is circular; however, other geometric or irregular shapes may be used. The fiducial pattern 330 may include more or fewer sub-patterns 320, and the sub-patterns 320 can be otherwise arranged. This example fiducial pattern 330 is 15×15 millimeters, but fiducial patterns 330 may be larger or smaller. The fiducial pattern 330 is configured to affect input light from an object field in front of the camera to cause a diffraction pattern at an image plane corresponding to a surface of a camera sensor.

FIG. 3B illustrates an example diffraction pattern 332 caused by a fiducial pattern 330 as illustrated in FIG. 3A, according to some embodiments. The fiducial pattern 330 effectively casts a shadow on the camera sensor, which shows up as a diffraction pattern 332 in images captured by the camera sensor. The diffraction pattern 332 is composed of multiple diffraction sub-patterns 322. In a single image, the pattern 332 is not visible. However, integrated over many video frames (e.g., 100 or more frames), the pattern 332 may be recovered and processed, for example using a deconvolution method, to recover information about the source diffraction pattern 330 and the diffraction sub-patterns 320.

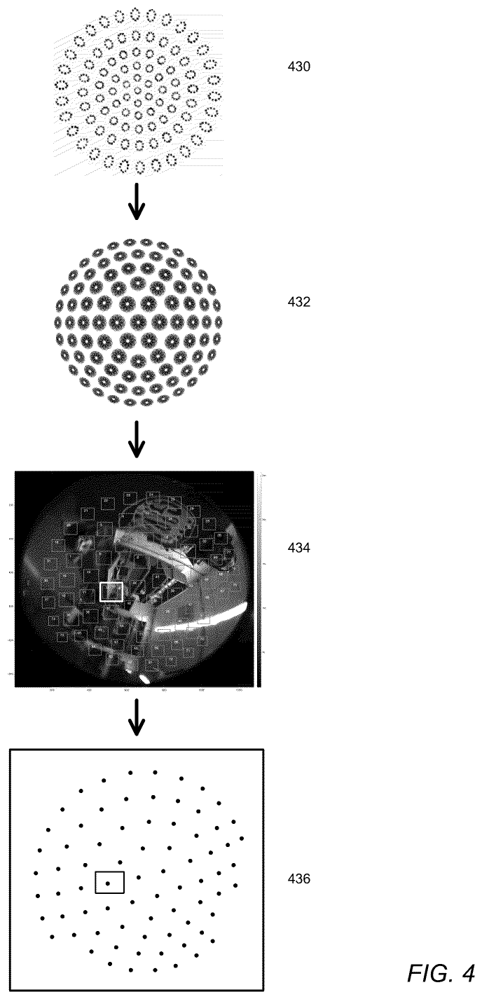

FIG. 4 graphically illustrates a process for extracting information from a diffraction pattern caused by a fiducial pattern, according to some embodiments. A cover glass or lens includes a fiducial pattern 430 that affects light passing through the glass or lens to form a diffraction pattern 432 at an image plane corresponding to a surface of the camera sensor. Multiple frames 434 of a video are processed to detect sub-patterns within the diffraction pattern 432. Information about the sub-patterns, for example centroids 436 corresponding to the sub-patterns in the fiducial pattern 430, is extracted from the frames 434, for example using a deconvolution technique.

The locations and arrangements of the detected centroids 436 may then be compared to the calibrated locations for the glass or lens to determine shift of the glass or lens with respect to the camera in one or more degrees of freedom. Offsets determined from the shift may then be provided to the image processing algorithms to account for any distortion in images captured by the camera caused by the shifted glass or lens.

In addition, the information extracted from the sub-patterns may encode information about the glass or lens, for example a serial number or prescription information. This information may be provided to image processing algorithms so that the algorithms can account for the particular distortion caused by the respective cover glass or lens attachment.

The white rectangle in 434 and the black rectangle 436 indicate an example sub-pattern centroid within the diffraction pattern 432 that is detected by the processing.

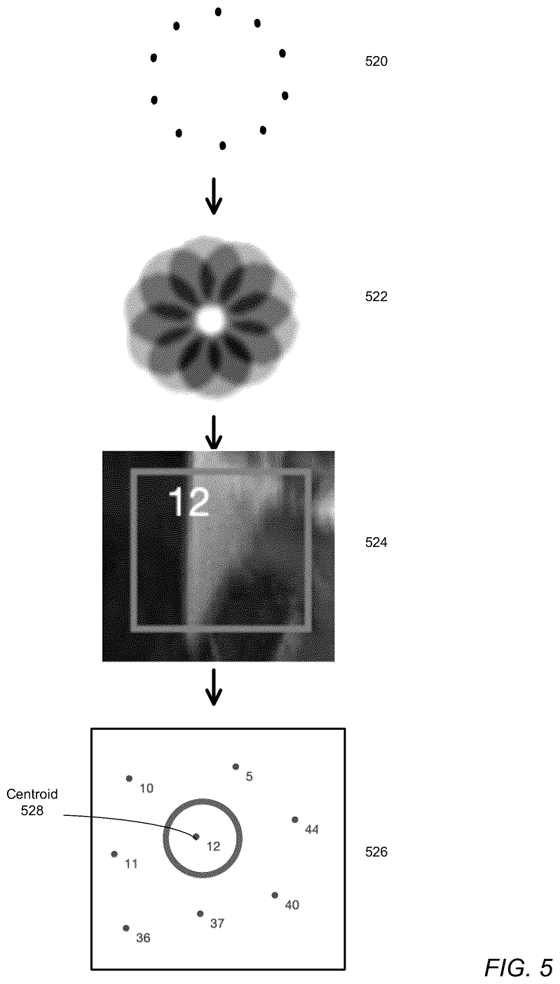

FIG. 5 graphically illustrates a process for extracting information from a diffraction sub-pattern caused by a sub-pattern of a fiducial pattern, according to some embodiments. A cover glass or lens includes a fiducial pattern that includes multiple sub-patterns 520 that each affect light passing through the glass or lens to form a respective diffraction sub-pattern 522 at an image plane corresponding to a surface of the camera sensor. Multiple frames of a video are processed to detect the centroids of individual sub-patterns 522 within the diffraction pattern, as illustrated in FIG. 4. A region 524 around a given centroid 528 can then be processed to detect dots in the diffraction sub-pattern 526 that correspond to dots in the fiducial sub-pattern 520.

The locations and arrangements of the dots in the diffraction sub-patterns 522 caused by the fiducial sub-patterns 520 may encode information about the glass or lens, for example a serial number or prescription information, that can be determined from the detected patterns 526. This information may be provided to image processing algorithms so that the algorithms can account for the particular distortion caused by the respective cover glass or lens attachment.

Collectively, the information 526 extracted from the diffraction sub-patterns 522 can be compared to the calibrated locations for the glass or lens to determine shift of the glass or lens with respect to the camera in one or more degrees of freedom. Offsets determined from the shift may then be provided to the image processing algorithms to account for any distortion in images captured by the camera caused by the shifted glass or lens.

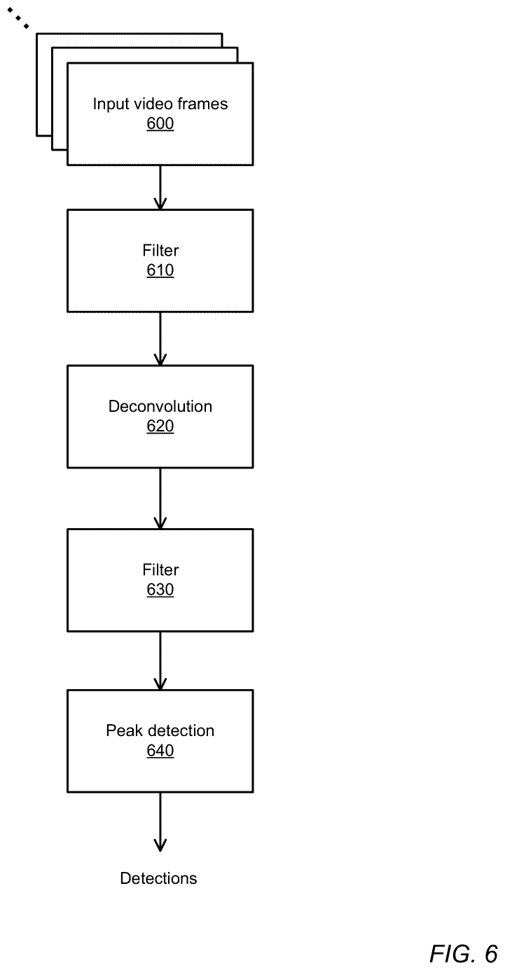

FIG. 6 illustrates the processing of input images to extract centroid or peak information from diffraction patterns in the images, according to some embodiments. At 600, multiple frames from video captured by the camera (e.g., 100 or more frames) through a glass or lens that includes a fiducial pattern are collected and input to the process. At 610, the frames are filtered to remove the background. At 620, deconvolution is performed with a known pattern for the fiducial pattern to recover the response. Deconvolution may be a single-stage or two-stage deconvolution, and may involve using one or more Fast Fourier Transforms (FFTs). Additional filtering 630 may be performed. Peak detection 640 is then performed to detect the centroids of the diffraction pattern caused by fiducial pattern on the cover glass or lens.

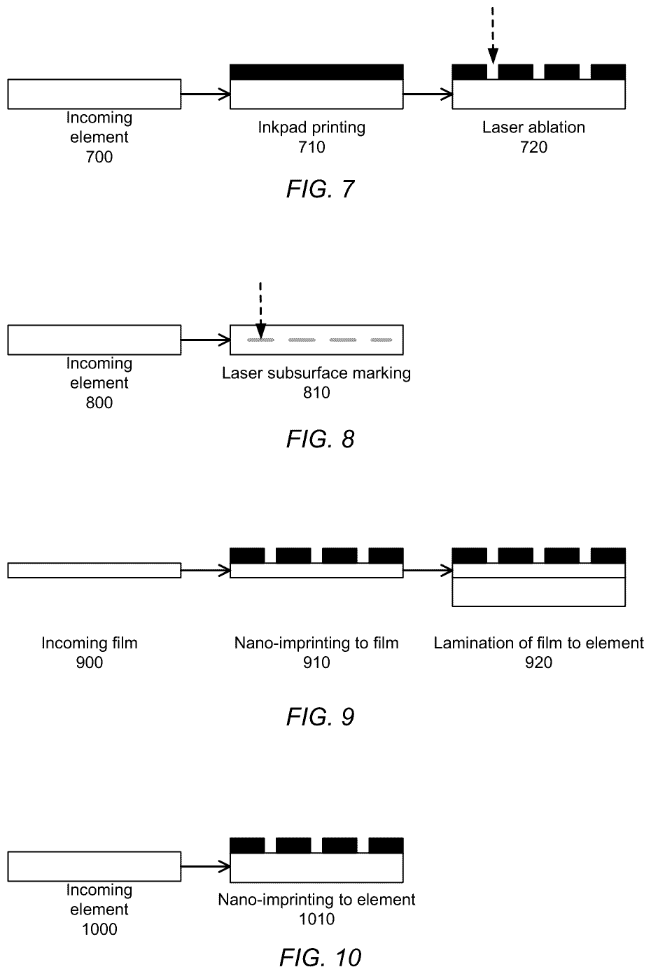

FIGS. 7 through 10 illustrate several example methods for creating fiducial patterns as described herein on or in a glass or plastic optical element, which may be a cover glass, attachable lens, or other transparent optical element. Note that some methods may work well for glass elements, while others may work well for plastic elements. In general, surface application methods may be preferable for glass elements, while surface and subsurface methods may work for plastic elements. For surface applications, the fiducial pattern may be created on the inside (camera facing) surface or on the outside surface, depending on the application.

FIG. 7 illustrates a pad print and laser ablation process for generating fiducial patterns, according to some embodiments. An incoming glass or plastic element 700 undergoes an inkpad printing 710. Laser ablation 720 is then used to etch the fiducial pattern in the ink.

FIG. 8 illustrates a laser subsurface marking process for generating fiducial patterns, according to some embodiments. This technique may work better for elements composed of a plastic material. An incoming element 800 has the fiducial pattern “burned” into the subsurface using a laser subsurface marking technique.

FIGS. 9 and 10 illustrate a nano-imprinting lithography process for generating fiducial patterns, according to some embodiments. In FIG. 9, incoming film 900 has the fiducial pattern printed on it using a nano-imprinting lithography technique. The film is then laminated 920 onto a surface of a glass or plastic element. In FIG. 10, the fiducial pattern is nano-imprinted 1010 directly on a surface of an incoming element 1000.

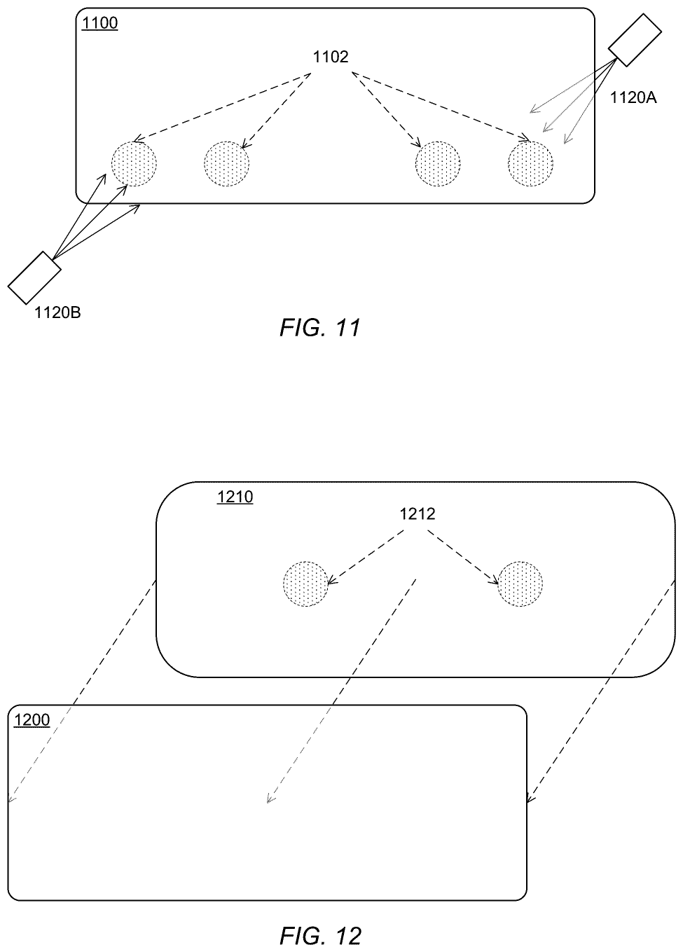

FIG. 11 illustrates example fiducial patterns on a cover glass 1100, according to some embodiments. One or more fiducial patterns 1102 as described herein may be formed on or in a cover glass 1100 using one of the techniques described in FIGS. 7 through 10. A fiducial pattern 1102 may form a diffraction pattern at the sensor of a respective outward facing camera 1120A. Video frames that include the diffraction pattern can be processed to determine information about the cover glass 1100 using a process as described herein. In some applications, an external (inward facing) camera 1120 may also capture frames that include diffraction patterns caused by the fiducial patterns 1102; these frames can be similarly processed to determine information about the cover glass 1100.

FIG. 12 illustrates example fiducial patterns on an attachable lens 1210, according to some embodiments. Lens 1210 may be configured to attach to an inside or outside surface of a cover glass 1200. One or more fiducial patterns 1202 as described herein may be formed on or in lens 1210 using one of the techniques described in FIGS. 7 through 10. A fiducial pattern 1202 may form a diffraction pattern at the sensor of a respective outward facing camera (not shown). Video frames that include the diffraction pattern can be processed to determine information about the lens 1210 using a process as described herein. In some applications, an external (inward facing) camera may also capture frames that include diffraction patterns caused by the fiducial patterns 1202; these frames can be similarly processed to determine information about the lens 1210. While not shown, cover glass 1200 may also include one or more fiducial patterns as shown in FIG. 11; in these embodiments, the fiducial patterns on the cover glass 1200 and lens 1210 may be positioned such that their diffraction patterns do not overlap on the camera sensor. In some embodiments, different cameras may be configured to capture and process video frames including the different diffraction patterns.

FIG. 13 illustrates another example fiducial pattern that includes multiple different sub-patterns, according to some embodiments. In this non-limiting example, the fiducial pattern 1302 is a single irregularly shaped “ring” of sub-patterns 1306, each sub-pattern 1306 including multiple markers or dots arranged in a pattern. The sub-patterns 1306 may be of different sizes. While this example shows a similar pattern of markers in each sub-pattern 1306, with the sub-patterns rotated to different angles, in some embodiments the sub-patterns 1306 may have different patterns and/or numbers of markers. Information can be encoded in the patterns of markers in the sub-patterns 1306, and/or in the number and arrangements of the sub-patterns 1306 within the fiducial pattern 1302.

FIG. 14 illustrates one of the sub-patterns from the fiducial pattern of FIG. 13, according to some embodiments. This non-limiting example shows that the markers 1408 are subsurface markers in a glass or plastic element 1400. Element 1400 may, for example, be a cover glass or an attachable lens. While FIG. 14 shows element 1400 as curved, the element 1400 may be flat depending on the application. The shape of element 1400 is given as an example, and is not limiting. In this example, fiducial pattern 1404 is formed on one side of the element 1400; however, the fiducial pattern 1404 may be formed elsewhere on the element, and may be larger or smaller in relation to the element 1400 than shown. Sub-pattern 1406 is expanded to show detail; each sub-pattern is formed of one or more markers 1408 formed in or on the element 1400.

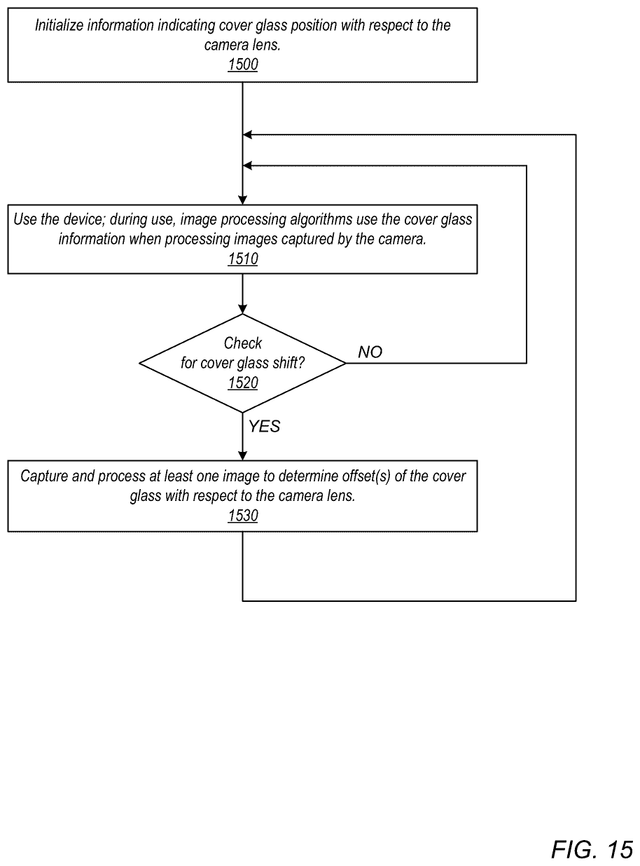

FIG. 15 is a flowchart of a method for detecting shifts in the cover glass of a device using fiducial patterns on the cover glass that cause diffraction patterns in images captured by cameras of the device, according to some embodiments. A similar method may be used to detect position and shifts in an attachable lens. The method of FIG. 15 may, for example, be implemented in the systems as illustrated in FIGS. 1A through IC. The method checks for shifts in the cover glass of a device relative to a camera of the device. As indicated at 1500, information indicating cover glass position with respect to the camera lens may be initialized, for example during a calibration of the device performed during or after manufacturing. As indicated at 1510, during use, algorithms (e.g., image processing algorithms) may use the cover glass position information when processing images captured by the camera. At 1520, the device may detect an event that might affect alignment of the cover glass with respect to the camera lens and that thus may require a check to determine if the cover glass has shifted. For example, the device may detect a sudden shock, for example due to dropping or bumping the device. As another example, a check may be performed each time the device is powered on. If an event is detected that requires a check, then at 1530 at least one image may be captured and processed to determine offset(s) of the cover glass with respect to the camera lens based on the diffraction pattern(s) in the image(s) caused by the fiducial pattern on the cover glass.

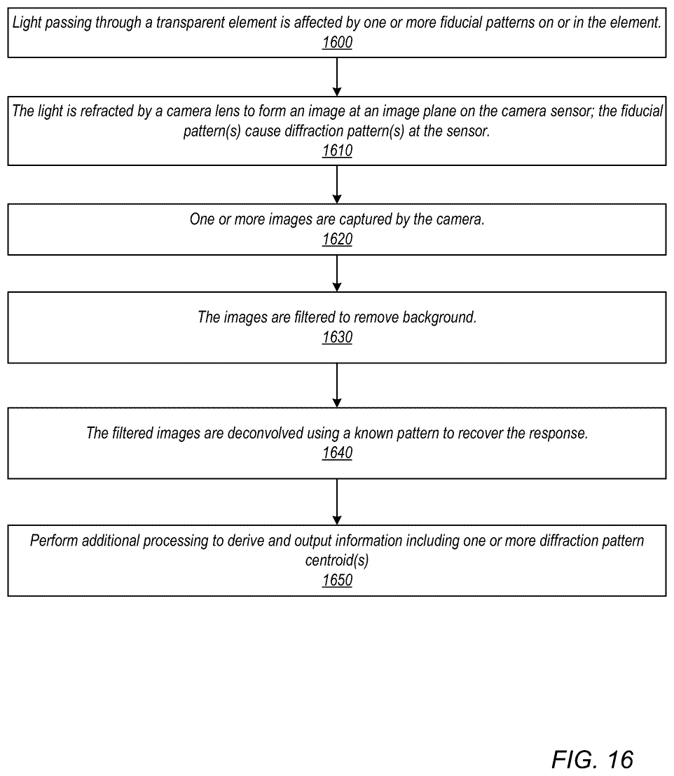

FIG. 16 is a flowchart of a method for deriving information from diffraction patterns causes by fiducial patterns on or in a glass or lens element, according to some embodiments. The method of FIG. 16 may, for example, be implemented at element 1530 of FIG. 15. As indicated at 1600, light passing through a transparent element (e.g., a cover glass or lens) in front of a camera is affected by one or more fiducial patterns on or in the element. As indicated at 1610, the light is refracted by a camera lens to form an image at an image plane on the camera sensor; the fiducial pattern(s) on the cover glass cause diffraction pattern(s) at the sensor as described herein. As indicated at 1620, one or more images are captured by the camera. As indicated at 1630, the images may be filtered to remove background. As indicated at 1640, a deconvolution technique is applied to the filtered images using a known pattern to recover the response. As indicated at 1650, additional processing may be performed to derive and output information including but not limited to centroids of the sub-patterns within the diffraction pattern(s). In some embodiments, offset(s) of the element with respect to the camera lens may be derived from the located centroids. In some embodiments, the location of the detected centroids may be compared to the calibrated locations for the cover glass to determine shift of the cover glass with respect to the camera in multiple degrees of freedom. The determined cover glass offsets may be provided to one or more image processing algorithms to account for any distortion in images captured by the camera caused by the shifted cover glass. In some embodiments, the information derived from the diffraction pattern may include information about the element, for example a serial number or optical prescription, that can be provided to image processing algorithms for use in processing images captured by the camera through the element.

### Extended Reality

A real environment refers to an environment that a person can perceive (e.g. see, hear, feel) without use of a device. For example, an office environment may include furniture such as desks, chairs, and filing cabinets; structural items such as doors, windows, and walls; and objects such as electronic devices, books, and writing instruments. A person in a real environment can perceive the various aspects of the environment, and may be able to interact with objects in the environment.

An extended reality (XR) environment, on the other hand, is partially or entirely simulated using an electronic device. In an XR environment, for example, a user may see or hear computer generated content that partially or wholly replaces the user's perception of the real environment. Additionally, a user can interact with an XR environment. For example, the user's movements can be tracked and virtual objects in the XR environment can change in response to the user's movements. As a further example, a device presenting an XR environment to a user may determine that a user is moving their hand toward the virtual position of a virtual object, and may move the virtual object in response. Additionally, a user's head position and/or eye gaze can be tracked and virtual objects can move to stay in the user's line of sight.

Examples of XR include augmented reality (AR), virtual reality (VR) and mixed reality (MR). XR can be considered along a spectrum of realities, where VR, on one end, completely immerses the user, replacing the real environment with virtual content, and on the other end, the user experiences the real environment unaided by a device. In between are AR and MR, which mix virtual content with the real environment.

VR generally refers to a type of XR that completely immerses a user and replaces the user's real environment. For example, VR can be presented to a user using a head mounted device (HMD), which can include a near-eye display to present a virtual visual environment to the user and headphones to present a virtual audible environment. In a VR environment, the movement of the user can be tracked and cause the user's view of the environment to change. For example, a user wearing a HMD can walk in the real environment and the user will appear to be walking through the virtual environment they are experiencing. Additionally, the user may be represented by an avatar in the virtual environment, and the user's movements can be tracked by the HMD using various sensors to animate the user's avatar.

AR and MR refer to a type of XR that includes some mixture of the real environment and virtual content. For example, a user may hold a tablet that includes a camera that captures images of the user's real environment. The tablet may have a display that displays the images of the real environment mixed with images of virtual objects. AR or MR can also be presented to a user through an HMD. An HMD can have an opaque display, or can use a see-through display, which allows the user to see the real environment through the display, while displaying virtual content overlaid on the real environment.

The following clauses describe example embodiments consistent with the drawings and the above description.

Clause 1. A system, comprising:
a camera comprising a camera lens and an image sensor;
a transparent element on an object side of the camera lens, the transparent element including a fiducial pattern configured to affect light received from an object field to cause a diffraction pattern in images formed by the camera lens at a surface of the image sensor, wherein the fiducial pattern comprises two or more fiducial sub-patterns each comprising one or more markers, and wherein the diffraction pattern comprises two or more diffraction sub-patterns corresponding to the fiducial sub-patterns; and
one or more processors configured to process two or more images captured by the camera to extract the diffraction pattern and to locate centroids of the diffraction sub-patterns on the image sensor.

Clause 2. The system as recited in clause 1, wherein the one or more processors are further configured to:
determine offsets of the transparent element with respect to the camera lens from the located centroids; and
apply the determined offsets to one or more images captured by the camera during processing of the one or more images to account for distortion in the one or more images caused by a corresponding shift in the transparent element with respect to the camera lens.

Clause 3. The system as recited in clause 2, wherein, to process two or more images captured by the camera to extract the diffraction pattern and to locate centroids of the diffraction sub-patterns on the image sensor, the one or more processors are configured to apply a deconvolution technique to the two or more images to recover a response corresponding to the diffraction pattern.

Clause 4. The system as recited in clause 3, wherein the one or more processors are configured to filter the two or more images to remove background prior to applying said deconvolution technique.

Clause 5. The system as recited in clause 3, wherein the deconvolution technique is a two-stage deconvolution.

Clause 6. The system as recited in clause 1, wherein the transparent element is a cover glass.

Clause 7. The system as recited in clause 6, wherein the camera and the cover glass are components of a head-mounted device (HMD).

Clause 8. The system as recited in clause 1, wherein the transparent element is a lens attachment.

Clause 9. The system as recited in clause 8, wherein the camera is a component of a device that includes a cover glass in front of the camera, and wherein the lens attachment is configured to be attached to an inside surface or an outside surface of the cover glass.

Clause 10. The system as recited in clause 1, wherein the fiducial pattern encodes information about the transparent element, and wherein the one or more processors are configured to further process the extracted diffraction pattern to:
locate the markers in the fiducial pattern corresponding to the centroids of the diffraction sub-patterns; and
determine the information about the transparent element from the located markers and corresponding centroids.

Clause 11. The system as recited in clause 10, wherein the encoded information includes one or more of an identifier and a serial number for the transparent element.

Clause 12. The system as recited in clause 10, wherein the transparent element is a lens formed according to a prescription for a user, and wherein the encoded information includes prescription information for the transparent element.

Clause 13. The system as recited in clause 10, wherein the one or more processors are configured to cause mechanical or software adjustments in the system based on the determined information about the transparent element to adapt the system to the particular transparent element.

Clause 14. The system as recited in clause 1, wherein the transparent element is composed of a glass or plastic material.

Clause 15. The system as recited in clause 1, wherein the fiducial pattern is formed on a surface of the transparent element using a pad print and laser ablation process.

Clause 16. The system as recited in clause 1, wherein the fiducial pattern is formed within the transparent element using a laser subsurface marking process.

Clause 17. The system as recited in clause 1, wherein the fiducial pattern is formed on a surface of the transparent element using a nano-imprinting lithography process.

Clause 18. The system as recited in clause 1, wherein the fiducial pattern is formed on a film using a nano-imprinting lithography process, and wherein the film is laminated onto a surface of the transparent element.

Clause 19. The system as recited in clause 1, wherein the fiducial pattern includes one or more circular or irregular rings of fiducial sub-patterns.

Clause 20. The system as recited in clause 19, wherein the one or more markers in each fiducial sub-pattern are arranged in a same pattern.

Clause 21. The system as recited in clause 19, wherein the one or more markers in at least two of the fiducial sub-patterns are arranged in a different pattern.

Clause 22. A method, comprising:
receiving light from an object field at a transparent element on an object side of a camera lens, the transparent element including a fiducial pattern comprising two or more fiducial sub-patterns each comprising one or more markers;
refracting, by the camera lens, the light received through the transparent element to form an image at a surface of an image sensor, wherein the fiducial pattern affects the light to cause a diffraction pattern in the image, wherein the diffraction pattern comprises two or more diffraction sub-patterns corresponding to the fiducial sub-patterns;
capturing, by the image sensor, two or more images;
applying, by one or more processors, a deconvolution technique to the two or more images to recover a response corresponding to the diffraction pattern; and
locating, by the one or more processors, centroids of the diffraction sub-patterns on the image sensor in the recovered diffraction pattern.

Clause 23. The method as recited in clause 22, further comprising
determining, by the one or more processors, a shift of the transparent element with respect to the camera lens from the located centroids; and
adjusting processing of one or more additional images captured by the camera to account for the determined shift in the transparent element with respect to the camera lens.

Clause 24. The method as recited in clause 23, wherein determining the shift of the transparent element with respect to the camera lens from the located centroids comprises comparing locations of the centroids on the image sensor to known locations on the image sensor determined during a calibration process.

Clause 25. The method as recited in clause 22, further comprising filtering the two or more images to remove background prior to applying said deconvolution technique.

Clause 26. The method as recited in clause 22, wherein the transparent element is a cover glass or an attachable lens composed of a glass or plastic material.

Clause 27. The method as recited in clause 22, wherein the fiducial pattern encodes information about the transparent element, the method further comprising
locating the markers in the fiducial pattern corresponding to the centroids of the diffraction sub-patterns; and
determining the information about the transparent element from the located markers and corresponding centroids.

Clause 28. A device, comprising:
a camera comprising a camera lens and an image sensor;
a transparent element on an object side of the camera lens, the transparent element including
a fiducial pattern configured to affect light received from an object field to cause a diffraction pattern in images formed by the camera lens at a surface of the image sensor, wherein the diffraction pattern comprises two or more sub-patterns corresponding to sub-patterns in the fiducial pattern; and
one or more processors configured to:
determine offsets of the transparent element with respect to the camera lens from the diffraction patterns in two or more images captured by the camera; and
apply the determined offsets to one or more images captured by the camera during processing of the one or more images to account for distortion in the one or more images caused by a corresponding shift in the transparent element with respect to the camera lens.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system, comprising:
a camera comprising a camera lens and an image sensor;
a transparent element on an object side of the camera lens, the transparent element including a fiducial pattern configured to affect light received from an object field to cause a diffraction pattern in images formed by the camera lens at a surface of the image sensor, wherein the fiducial pattern comprises two or more fiducial sub-patterns each comprising one or more markers, and wherein the diffraction pattern comprises two or more diffraction sub-patterns corresponding to the fiducial sub-patterns; and
one or more processors configured to process two or more images captured by the camera to extract the diffraction pattern and to determine locations of the diffraction sub-patterns on the image sensor.

2. The system as recited in claim 1, wherein the one or more processors are further configured to:
determine offsets of the transparent element with respect to the camera lens from the determined locations; and
apply the determined offsets to one or more images captured by the camera during processing of the one or more images to account for distortion in the one or more images caused by a corresponding shift in the transparent element with respect to the camera lens.

3. The system as recited in claim 2, wherein, to process two or more images captured by the camera to extract the diffraction pattern and to determine locations of the diffraction sub-patterns on the image sensor, the one or more processors are configured to apply a deconvolution technique to the two or more images to recover a response corresponding to the diffraction pattern.

4. The system as recited in claim 3, wherein the one or more processors are configured to filter the two or more images to remove background prior to applying said deconvolution technique.

5. The system as recited in claim 3, wherein the deconvolution technique is a two-stage deconvolution.

6. The system as recited in claim 1, wherein the transparent element is a cover glass, and the camera and the cover glass are components of a head-mounted device (HMD).

7. The system as recited in claim 1, wherein the transparent element is a lens attachment, wherein the camera is a component of a device that includes a cover glass in front of the camera, and wherein the lens attachment is configured to be attached to an inside surface or an outside surface of the cover glass.

8. The system as recited in claim 1, wherein the fiducial pattern encodes information about the transparent element, and wherein the one or more processors are configured to further process the extracted diffraction pattern to:
locate the markers in the fiducial pattern corresponding to centroids of the diffraction sub-patterns; and
determine the information about the transparent element from the located markers and corresponding centroids.

9. The system as recited in claim 8, wherein the encoded information includes one or more of an identifier and a serial number for the transparent element.

10. The system as recited in claim 8, wherein the transparent element is a lens formed according to a prescription for a user, and wherein the encoded information includes prescription information for the transparent element.

11. The system as recited in claim 8, wherein the one or more processors are configured to cause mechanical or software adjustments in the system based on the determined information about the transparent element to adapt the system to the particular transparent element.

12. The system as recited in claim 1, wherein:
the fiducial pattern is formed on a surface of the transparent element using a pad print and laser ablation process, a laser subsurface marking process, or a nano-imprinting lithography process, or
the fiducial pattern is formed on a film using a nano-imprinting lithography process, and the film is laminated onto a surface of the transparent element.

13. The system as recited in claim 1, wherein the fiducial pattern includes one or more circular or irregular rings of fiducial sub-patterns.

14. The system as recited in claim 13, wherein the one or more markers in each fiducial sub-pattern are arranged in a same pattern.

15. The system as recited in claim 13, wherein the one or more markers in at least two of the fiducial sub-patterns are arranged in a different pattern.

16. A method, comprising:
receiving light from an object field at a transparent element on an object side of a camera lens, the transparent element including a fiducial pattern comprising two or more fiducial sub-patterns each comprising one or more markers;
refracting, by the camera lens, the light received through the transparent element to form an image at a surface of an image sensor, wherein the fiducial pattern affects the light to cause a diffraction pattern in the image, wherein the diffraction pattern comprises two or more diffraction sub-patterns corresponding to the fiducial sub-patterns;
capturing, by the image sensor, two or more images;
applying, by one or more processors, a deconvolution technique to the two or more images to recover a response corresponding to the diffraction pattern; and
determining, by the one or more processors, locations of the diffraction sub-patterns on the image sensor in the recovered diffraction pattern.

17. The method as recited in claim 16, further comprising:
determining, by the one or more processors, a shift of the transparent element with respect to the camera lens from the determined locations; and
adjusting processing of one or more additional images captured by the camera to account for the determined shift in the transparent element with respect to the camera lens.

18. The method as recited in claim 17, wherein determining the shift of the transparent element with respect to the camera lens from the determined locations comprises comparing locations of the determined locations on the image sensor to known locations on the image sensor determined during a calibration process.

19. The method as recited in claim 16, wherein the fiducial pattern encodes information about the transparent element, the method further comprising
locating the markers in the fiducial pattern corresponding to centroids of the diffraction sub-patterns; and
determining the information about the transparent element from the located markers and corresponding centroids.

20. A device, comprising:
a camera comprising a camera lens and an image sensor;
a transparent element on an object side of the camera lens, the transparent element including a fiducial pattern configured to affect light received from an object field to cause a diffraction pattern in images formed by the camera lens at a surface of the image sensor, wherein the diffraction pattern comprises two or more sub-patterns corresponding to sub-patterns in the fiducial pattern; and
one or more processors configured to:
determine offsets of the transparent element with respect to the camera lens from the diffraction patterns in two or more images captured by the camera; and
apply the determined offsets to one or more images captured by the camera during processing of the one or more images to account for distortion in the one or more images caused by a corresponding shift in the transparent element with respect to the camera lens.
